(19) United States
(12) Patent Application Publication
(10) Pub. No.: US 2006/0139667 A1
(43) Pub. Date: Jun. 29, 2006

(54) Signal output apparatus, sheet identification apparatus, image forming apparatus including the same, and method for identifying sheet material

(75) Inventors: Toshitsugu Morimoto, Kawasaki-shi (JP); Masaaki Kanashiki, Yokohama-shi (JP); Norio Kaneko, Atsugi-shi (JP); Takehiko Kawasaki, Atsugi-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/299,088

(22) Filed: Dec. 9, 2005

(30) Foreign Application Priority Data
Dec. 28, 2004 (JP) 2004-379831
Dec. 28, 2004 (JP) 2004-379830
Nov. 2, 2005 (JP) 2005-319644

(51) Int. Cl. G06F 15/00; H04N 1/60; G06K 1/00

(52) U.S. Cl. 358/1.9

(57) ABSTRACT

At least one exemplary embodiment is directed to a signal output apparatus including an impact application unit configured to generate and apply an impact to a sheet material, an impact reception unit configured to receive the applied impact, a signal output unit configured to output a signal in response to the impact received by the impact reception unit from the impact application unit and a calibration unit configured to calibrate at least one of the impact applied by the impact application unit and the signal output from the signal output unit.

### BACKGROUND OF THE INVENTION

1. Field of the Invention

The present invention relates to a signal output apparatus, and more particularly, though not exclusively, to an identification apparatus configured to identify characteristics of a sheet material.

2. Description of the Related Art

A conventional image forming apparatus, (e.g., a copy machine, a printer, or a facsimile machine), forms images on a recording medium (e.g., sheet material). The sheet material used for image formation may be regular paper, such as copy paper, glossy paper, coated paper, recycled paper, overhead projector (OHP) film, or other sheet material capable of having an image formed thereon as known by one of ordinary skill in the relevant arts and equivalents.

For an image forming apparatus to form high quality images on various different sheet materials, it is desirable for the image forming apparatus to be able to carry out image formation in accordance with the type of the sheet material and, moreover, to be able to automatically identify the type of the sheet material before carrying out the image formation.

To identify the characteristics of a sheet material, an impact is applied to the sheet material using an impact application member. Then, a peak value, a peak number, or the intervals between peaks of an output signal obtained as a result of the impact wave being attenuated by the sheet material is detected. The detected result is checked against information on sheet materials stored in advance so as to identify the characteristics of the sheet material (Japanese Patent Laid-Open No. 2004-026486).

A conventional image forming apparatus, (e.g., a copy machine, a printer, or a facsimile), is capable of forming an image on a sheet material, (e.g., regular copy paper, glossy paper, coated paper, or transparent resin film).

Such a conventional image forming apparatus, capable of forming images on materials sheet materials, carries out an optimal image forming process in accordance with the type of the sheet material. In order to carry out an optimal image formation process for a predetermined type of the sheet material, the image forming apparatus includes a sheet identification apparatus configured to identify the type of the sheet material to be used for the image formation.

As illustrated in FIG. 13, a mark M, such as a number code or a symbol, is applied on a sheet material S in advance. Then, this mark M is read by a sensor provided in the image forming apparatus. In this way, the type of the sheet material S can be identified, and an optimal image forming mode can be selected on the basis of the mark M (U.S. Pat. No. 6,097,497).

There is also a conventional sheet identification apparatus configured to irradiate the surface of a sheet material with light, receive the reflected light, identify the characteristics of the sheet material on the basis of the reflected light, and set an optimal image forming mode for the apparatus (Japanese Patent Laid-Open No. 10-221905).

There is also a conventional sheet identification apparatus configured to scan the surface of a sheet material with a sensor having a probe on the tip of a piezoelectric element, identify the characteristics of the sheet material on the basis of the scanning, and set an optimal image forming mode for the apparatus (U.S. Pub. No. 2002181963).

There is also a conventional sheet identification apparatus configured to detect the roughness of the surface of a sheet material by rubbing a piezoelectric apparatus against the surface of the sheet material, identify the characteristics of the sheet material on the basis of the detection, and set an optimal image forming mode for the apparatus (Japanese Patent Laid-Open No. 2000-356507).

Another conventional sheet identification apparatus is configured to use a pressure sensor (i.e., impact sensor, hereinafter referred to as a ‘pressure sensor’) for detecting the elasticity of a sheet material, identify the characteristics of the sheet material on the basis of the detection, and setting an optimal image forming mode for the apparatus (Japanese Patent Laid-Open No. 2003-276856).

However, the signal output apparatus discussed in Japanese Patent Laid-Open No. 2004-026486 is not capable of responding to changes in the impact and/or the output signal due to aging or degradation of the impact generating member. In some cases, the signal output apparatus is not capable of applying stable impact strokes to the sheet material. Moreover, changes in temperature and/or humidity may change the impact and/or the output signal due to thermal expansion of the members.

For example, if an impact application member that is easily affected by aging is used, the impact and/or the output signal may change over time. By using the spring of the impact application member many times to apply an impact, the tension of the spring may be weakened or the shape of the tip of the spring may be deformed.

Moreover, if an impact application member that is easily affected by environmental changes is used, the impact and/or the output signal may change over time. For example, an environmental change may cause a change in the oscillation characteristics of a spring used as an impact application member, a sensor, such as a piezoelectric element, used as an impact detection device, and/or a rubber buffer used to reduce the oscillation of the sensor.

The sheet identification apparatus configured to use a marking system discussed in U.S. Pat. No. 6,097,497 reads a mark M applied on a sheet S in advance to identify the sheet material. Such a sheet identification apparatus is capable of accurately identifying a sheet material. However, if the sheet material is not marked, the sheet material cannot be identified.

In other words, such a sheet identification apparatus is only capable of identifying a sheet material having a mark M and is not capable of identifying a sheet material without a mark M.

Furthermore, a special device for marking the sheet material and time for applying a mark are required, causing an increase in costs.

The apparatuses discussed in US Pub. No. 2002181963 and Japanese Patent Laid-Open Nos. 10-221905, 2000-356507, and 2003-276856 do not directly discuss accurately obtaining information on a sheet material.

For the apparatuses discussed in US Pub. No. 2002181963 and Japanese Patent Laid-Open Nos. 10-221905 and 2000-356507, further improvements in the detection and identification capabilities and costs can be made.

The apparatus discussed in Japanese Patent Laid-Open No. 2003-276856 carries out a sequence for identifying a sheet material at timings such as when a sheet type detection signal is output, when the power of the image forming apparatus is turned on, and when a paper-feeding cassette is set. Therefore, the sheet material is sent back and forth within the apparatus in a manner such that the sheet material is first sent to the detection device for identification and then is returned to the paper-feeding cassette. As a result, high-speed image formation becomes difficult.

When a pressure sensor is used, in some case, the voltage output by the pressure sensor is changed due to temperature, humidity, and/or aging (hereinafter collectively referred to as ‘environmental conditions’). As a result, the capability of the apparatus to identify a sheet material is reduced.

### SUMMARY OF THE INVENTION

At least one exemplary embodiment is directed to the identification of sheet materials (e.g., molded products of organic and inorganic materials including metal, alloy, plastic, and ceramic, and compound materials thereof).

At least one exemplary embodiment is directed to an identification apparatus configured to identify the characteristics of a sheet material (e.g., recording paper used for inkjet printers, laser beam printers, and copy machines, and various other films). At least one further exemplary embodiment is directed to an image forming apparatus including the signal output apparatus.

At least one exemplary embodiment is directed to an apparatus that identifies the characteristics of a sheet material by applying an impact to the sheet material to be identified.

Moreover, at least one exemplary embodiment is directed to a signal output apparatus, a sheet identification apparatus, an image forming apparatus including the same, and a method for identifying the characteristics of a sheet material. At least one exemplary embodiment is directed to an apparatus configured to identify the characteristics of a sheet material by applying an impact to the sheet material and detecting the elasticity of the sheet material.

An output signal apparatus, a sheet identification apparatus, and an image forming apparatus including the same according to exemplary embodiments have improved reliability by calibrating the applied impact or the output signal in accordance with the conditions.

The output signal apparatus, a sheet identification apparatus, and an image forming apparatus including the same according to exemplary embodiments are capable of stable impact application to a sheet material to identify the type of the sheet material in a highly accurate manner. The output signal apparatus, a sheet identification apparatus, and an image forming apparatus including the same according to exemplary embodiments can have simple structures and are capable of identifying the type of a sheet material without applying a noticeable mark on the sheet material.

A signal output apparatus according to at least one exemplary embodiment includes an impact application unit configured to generate and apply an impact to a sheet material, an impact reception unit configured to receive the applied impact, a signal output unit configured to output a signal in response to the impact received by the impact reception unit from the impact application unit where the signal output unit is disposed on at least one of the impact application unit side and the impact reception unit side, and a calibration unit configured to calibrate at least one of the impact applied by the impact application unit and the signal output from the signal output unit.

A sheet identification apparatus according to at least one exemplary embodiment includes a signal output apparatus having a calibration unit, and a storage unit configured to store information on a sheet material, where the image forming apparatus has a function for identifying a sheet material on the basis of an output signal from the signal output apparatus and information stored in the storage unit.

An image forming apparatus according to at least one exemplary embodiment includes the signal output apparatus or the sheet identification apparatus.

The signal output apparatus according to at least one exemplary embodiment includes an impact application unit, an impact reception unit configured to receive the applied impact and a signal output unit configured to output a signal corresponding to the impact received by the impact reception unit, where the impact application unit has an impact calibration unit.

The impact calibration unit according to at least one exemplary embodiment carries out calibration on the basis of a signal output from the signal output unit in response to the impact being received by the impact reception unit from the impact application unit while the sheet material is not interposed between the impact application unit and impact reception unit.

The sheet identification apparatus according to at least one exemplary embodiment includes the signal output apparatus and a storage unit configured to store information on a sheet material, where the sheet identification apparatus is capable of identifying a sheet material on the basis of the signal from the signal output apparatus and the information stored in the storage unit.

The image forming apparatus according to at least one exemplary embodiment includes an image forming unit configured to form images on a sheet material and a sheet conveying apparatus configured to convey the sheet material, where image forming conditions or sheet conveying conditions can be set on the basis of the information obtained from the sheet identification apparatus.

The sheet identification apparatus according to at least one exemplary embodiment configured to identify a sheet material conveyed through a conveying path which can include an impact application unit configured to apply an impact to a sheet material with an impact application member in which the impact applied by the impact application member can be changed freely, an indirect impact detection unit configured to detect an impact received through a sheet material from the impact application member and disposed opposite side of the conveying path from the impact application member, a direct impact detection unit having the same structure as the indirect impact detection unit configured to detect an impact applied by the impact application member when a sheet material is not provided, and an identification unit configured to identify a sheet material on the basis of an impact received through the sheet material.

According to at least one exemplary embodiment, the impact application member is capable of freely calibrating the impact by changing the velocity of the impact application member when an impact is being applied.

According to at least one exemplary embodiment, the impact application member is capable of freely calibrating the impact by changing the weight of the impact application member when an impact is being applied.

A signal output apparatus according to at least one exemplary embodiment includes an impact application unit, an impact reception unit configured to received an impact, a signal output unit configured to output a signal in accordance with the impact received by the impact reception unit, and an amplifying unit configured to amplify the signal from the signal output unit, where the amplification of the amplifying unit is variable.

An amplifying unit according to at least one exemplary embodiment is capable of changing the amplification to a predetermined value on the basis of the signal from the signal output unit configured to output a signal corresponding to the impact received by the impact reception unit when a sheet material is not interposed between the impact application unit and the impact reception unit.

The signal output apparatus according to at least one exemplary embodiment includes a warning output unit configured to output warning information when the signal sent from the signal output unit in response to an impact received by the impact reception unit from the impact application unit does not equal the predetermined value even when the amplification is changed when a sheet material is not interposed between the impact application unit and the impact reception unit.

The sheet identification apparatus according to at least one exemplary embodiment includes the signal output apparatus and the storage unit configured to store information on the sheet materials and is capable of identifying a sheet material on the basis of the signal sent from the signal output apparatus and the information stored in the storage unit.

The image forming apparatus according to at least one exemplary embodiment includes an image forming unit configured to form images on a sheet material and a sheet conveying apparatus configured to convey the sheet material, where image forming conditions or sheet conveying conditions can be set on the basis of the information obtained from the sheet identification apparatus.

An image forming apparatus according to at least one exemplary embodiment includes, within the image forming apparatus, an impactor configured to apply an impact to a sheet material and a sheet identification unit configured to identify a sheet material. The image forming apparatus can have a signal output function for outputting an electric signal generated by a pressure sensor when the pressure sensor detects impact energy applied by the impactor after some of the impact energy is absorbed by the elasticity of the sheet material. On the basis of an electric signal obtained by directly applying an impact to the pressure sensor from the impactor when a sheet material is not provided and a electric signal obtained by the pressure sensor by detecting impact energy applied by the impactor after some of the impact energy is absorbed by the elasticity of the sheet material, the amplification of an amplifier configured to amplify the output voltage from a pressure sensor is changed to identify a sheet material by obtaining the sheet identification unit output voltage, which can be substantially equal to the voltage of the initial setting. The sheet identification unit output voltage, which can be substantially equal to the voltage of the initial setting when an electric signal obtained by directly applying an impact to the pressure sensor from the impactor when a sheet material is not provided changes due to environmental conditions.

The sheet identification apparatus according to at least one exemplary embodiment includes a pressure sensor configured to detect the impact energy received after some of the impact energy is absorbed by the elasticity of the sheet material and to have a mechanical force (distortion)/electric energy conversion characteristics that allows the pressure sensor to output an electric signal corresponding to the strength of the impact applied to the pressure sensor.

The pressure sensor according to at least one exemplary embodiment can be a linear motor (voice coil).

The pressure sensor according to at least one exemplary embodiment can be a piezoelectric element.

The image forming apparatus according to at least one exemplary embodiment includes an image forming unit and one of the above-discussed sheet identification apparatus, where the image forming unit is configured to form an image according to conditions corresponding to the type of the sheet material identified by the sheet identification apparatus.

The sheet identification apparatus according to at least one exemplary embodiment can be disposed upstream of the image forming unit.

The impact application process according to at least one exemplary embodiment can be repeated multiple times.

When repeating the pact application process according to at least one exemplary embodiment, the strength of the impact applied to a sheet material is changed.

A method for identifying a sheet material according to at least one exemplary embodiment includes the steps of applying a predetermined impact by an impact application unit to an impact reception unit with a sheet material being provided, outputting the impact applied to the sheet material as an output signal from the impact reception unit, identifying the sheet material on the basis of the output signal and information provided in advance for identifying the sheet material, obtaining an output signal by applying an impact to the impact reception unit without a sheet material to be identified being provided where the obtaining step being carried out before the applying step, and adjusting an impact generated at the impact application unit so that the value of the output signal corresponding to the generated impact is within a predetermined range.

Another method for identifying a sheet material according to at least one exemplary embodiment includes the steps of applying a predetermined impact by an impact application unit to an impact reception unit with a sheet material being provided, outputting the impact applied to the sheet material as an output signal from the impact reception unit, identifying the sheet material on the basis of the output signal and information provided in advance for identifying the sheet material, obtaining an output signal by applying an impact to the impact reception unit without a sheet material to be identified being provided where the obtaining step being carried out before the applying step, and changing a signal from a signal output unit so that the value of the output signal will be included within a predetermined range.

Further features of the present invention will become apparent from the following description of exemplary embodiments (with reference to the attached drawings).

### BRIEF DESCRIPTION OF THE DRAWINGS

FIG. 1 is a block diagram illustrating the functional structure of a sheet identification apparatus according to a first exemplary embodiment.

FIG. 2A is a cross-sectional view of a configuration adapted to detect the impact generated by an impact application member when a sheet material is not provided. FIG. 2B is a cross-sectional view of a configuration adapted to detect the impact generated by an impact application member when a sheet material is provided.

FIG. 3 is flow chart illustrating an operational process for identifying a sheet material.

FIG. 4 illustrates a perspective view of the structure of an impact application member according to a second exemplary embodiment.

FIG. 5 illustrates a view of the structure of an impact application member according to a third exemplary embodiment.

FIG. 6 illustrates a schematic view of a laser beam printer that is an example of an image forming apparatus including a sheet identification apparatus according to at least one exemplary embodiment.

FIG. 7 illustrates a schematic view of the structure of the sheet identification apparatus shown in FIG. 6.

FIG. 8 illustrates the timing of the sheet identification operation carried out by the sheet identification apparatus shown in FIG. 6.

FIG. 9 is a graph illustrating the relationship between the densities of recording paper and the output voltages.

FIG. 10 is a graph illustrating the relationship between the velocity of the impact applied to the impact detection unit and the signal output from the impact detection unit.

FIG. 11 is a graph illustrating the relationship between the thickness of sheets of paper having different basis weights and the signal output from the impact detection unit.

FIG. 12 illustrates a cross-section view of the structure of an impact application unit having a member for reducing flopping of a sheet material.

FIG. 13 illustrates a sheet material having a mark used for identification by a conventional sheet identification apparatus.

### DESCRIPTION OF THE EMBODIMENTS

The following description of exemplary embodiment(s) is merely illustrative in nature and is in no way intended to limit the invention, its application, or uses.

Exemplary embodiments can be operatively connected to various image forming apparatus, (e.g., a copy machine, a printer, or a facsimile).

Processes, techniques, apparatus, and materials as known by one of ordinary skill in the art may not be discussed in detail but are intended to be part of the enabling description where appropriate. For example, springs are mentioned and any material that can be used to form springs should fall within the scope of exemplary embodiments (e.g., metallic).

Additionally exemplary embodiments are not limited to visual imaging forming apparatus, for example the system can be designed for use with infrared and other wavelength imaging systems and associated sheet materials.

Notice that similar reference numerals and letters refer to similar items in the following figures, and thus once an item is defined in one figure, it may not be discussed or further defined in the following figures.

Exemplary embodiments will be described below with reference to the drawings.

### First Exemplary Embodiment

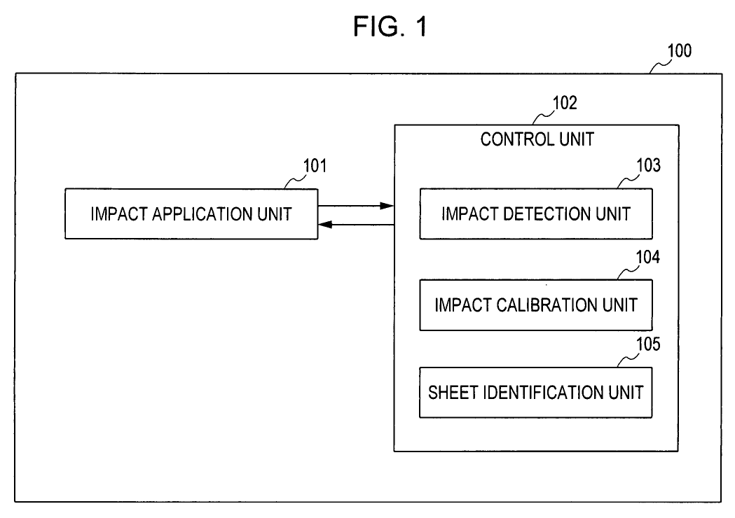

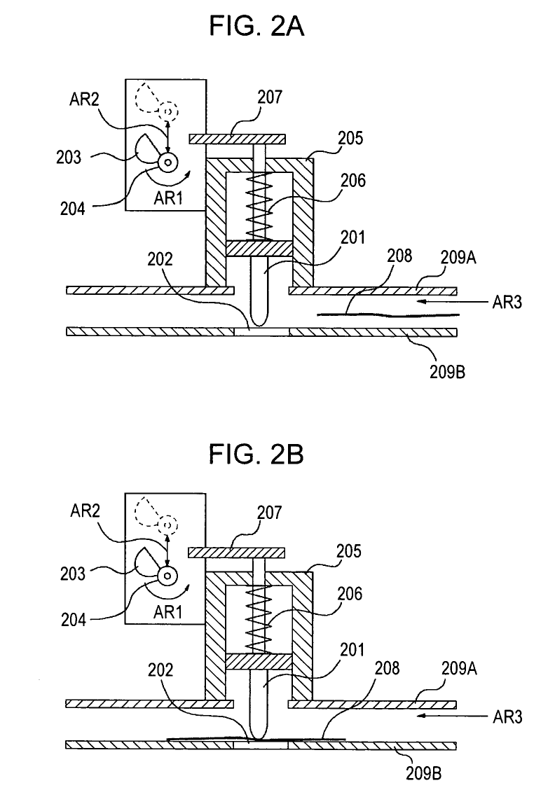

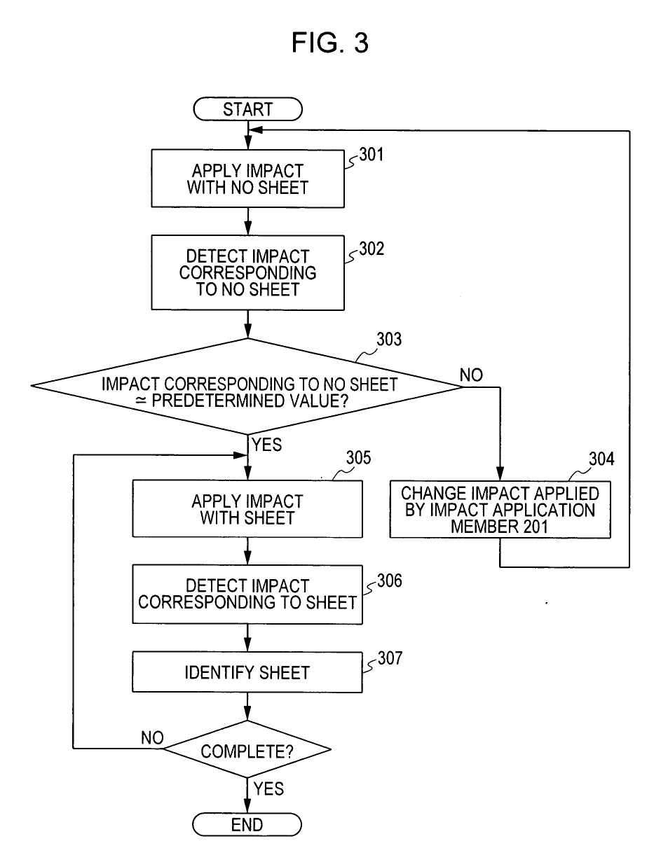

A sheet identification apparatus according to a first exemplary embodiment will be described with reference to FIGS. 1 to 3. FIG. 1 is a block diagram illustrating the functional structure of the sheet identification apparatus 100 according to the first exemplary embodiment. FIG. 2A is a cross-sectional view of a configuration adapted to detect the impact generated by an impact application member when a sheet material is not provided. FIG. 2B is a cross-sectional view of a configuration adapted to detect the impact generated by an impact application member when a sheet material is provided. FIG. 3 is flow chart illustrating an operational process for identifying a sheet material.

First, the functional structure of the sheet identification apparatus 100 according to the first exemplary embodiment will be described. The sheet identification apparatus 100 includes an impact application unit 101 and a control unit 102. The control unit 102 includes an impact detection unit 103 configured to detect an impact applied with a sheet material provided and an impact applied without a sheet material provided. The control unit 102 also includes an impact calibration unit 104 configured to control the impact application unit 101 so as to calibrate the impact to be applied and a sheet identification unit 105 configured to identify a sheet material on the basis of an impact applied with a sheet material provided.

The sheet identification apparatus 100 is capable of identifying various dynamic characteristics, such as rigidity, density, and/or thickness, of a sheet material. To identify such characteristics, the impact application unit 101 applies an impact to the sheet material and detects the applied impact through the sheet material with the impact detection unit 103. The sheet identification apparatus 100 is capable of obtaining information of a sheet material corresponding to changes caused by environmental factors, such as temperature and humidity. Information having correlations with the rigidity, density, and thickness of a sheet material can be known on the basis of the correlations. For example, if the sheet material is recording paper used for various printing methods, such as electrophotography or inkjet printing, the unevenness and the coarseness of the surface of the paper and the unevenness and difference between each sheet of paper can be detected. Moreover, if the change pattern of thickness and density of the sheet material due to temperature and/or humidity is known, the moisture content of the sheet material can be determined on the basis of the change pattern.

Next, the impact application unit 101 and the impact detection unit 103 will be described. The impact application unit 101, shown in FIG. 1, includes an impact application member 201, a piezoelectric element 202, a cam 203, a fixed shaft 204, a guide 205, a spring 206, and an impact increasing member 207, as shown in FIGS. 2A and 2B. The piezoelectric element 202, shown in FIGS. 2A and 2B, is disposed flush to one side of a sheet (e.g., paper) conveying guide (e.g., 209B) but is not limited to this position. A sheet material 208 is conveyed through a sheet conveying guides 209A-B, which is part of a conveying path in the image forming apparatus. The sheet material 208 is conveyed between the sheet conveying guides 209A and 209B in the direction indicated by an arrow AR3 by a sheet (e.g., paper) conveying unit, not shown in the drawings, at a predetermined speed.

The impact application member 201 applies an impact to the piezoelectric element 202 through the sheet material 208 so as to detect the impact when a sheet material is provided, whereas the impact application member 201 applies an impact directly to the piezoelectric element 202 so as to detect the impact when a sheet material is not provided. The piezoelectric element 202 and the impact application member 201 are disposed on opposite side of the sheet conveying guides 209A-B. The piezoelectric element 202 can be a sensor configured to generate an electric output signal in accordance with a mechanical external force due to vibration, such as vibration caused by an impact.

The cam 203 is a member configured to pull up the impact application member 201. The fixed shaft 204 functions as a rotary shaft of the cam 203. By rotating the cam 203 in the direction indicated by the arrow AR1, as shown in FIGS. 2A and 2B, with a motor (not shown in the drawings), the impact increasing member 207 is pulled up. As a result, the impact application member 201 is pulled upward. Since the cam 203 is a semi-circular column, the impact increasing member 207 is released when the cam 203 exceeds a predetermined rotational angle. The fixed shaft 204 is movable in a direction parallel to the direction the impact application member 201 is operated (i.e., the direction indicated by an arrow AR2). The fixed shaft 204 is operated in accordance with the impact calibration unit 104, not shown in FIGS. 2A and 2B.

The guide 205 holds the impact application member 201 and maintains the movement direction of the impact application member 201. The spring 206 is disposed in the vicinity of the connecting part of the impact application member 201 and the impact increasing member 207. The spring 206 is compressed when the impact application member 201 is pulled upward by the cam 203 and is extended to release and accelerate the impact application member 201. In this way, the impact application member 201 applies an impact to the piezoelectric element 202 and the sheet material 208.

It is suitable to use a non-elastic member, such as metal or hard plastic having low elasticity, for the impact application member 201 so that the generated impact is not self-inflicted.

The sheet material 208 is conveyed along the sheet conveying guide 209 in the direction indicated by an arrow AR3. FIG. 2A illustrates a case in which the sheet material 208 is not interposed (not provided) between the impact application member 201 and the piezoelectric element 202. FIG. 2B illustrates a case in which the sheet material 208 is interposed (provided) between the impact application member 201 and the piezoelectric element 202.

Next, the operation of the sheet identification apparatus 100 according to the first exemplary embodiment will be described. If the sheet material 208 is not interposed between the impact application member 201 and the piezoelectric element 202, for example, at the moment the power of the image forming apparatus is turned on, a motor (not shown in the drawings) is controlled by the impact detection unit 103 of the control unit 102. As a result, the cam 203 of the impact application unit 101 is rotated in the direction indicated by the arrow AR1. In this way, the cam 203 pulls up the impact application member 201 along the guide 205 and holds the impact application member 201 in this pulled-up position by pulling the impact increasing member 207. As a result, the spring 206 is compressed. Since the cam 203 is a semi-circular column, when the cam 203 is rotated, the impact application member 201 is released from its pulled-up state. Accordingly, the impact application member 201 is accelerated when the spring 206 is extended so as to apply an impact directly to the piezoelectric element 202 without the sheet material 208 being provided (Step 301, FIG. 3).

At this time, the piezoelectric element 202 generates a voltage signal corresponding to the impact applied directly to the piezoelectric element 202. This voltage signal is transmitted to the impact detection unit 103 of the control unit 102, shown in FIG. 1. In this way, the impact detection unit 103 detects the impact applied directly to the piezoelectric element 202 when a sheet material is not provided (Step 302, FIG. 3). Furthermore, a voltage signal corresponding to an impact applied without a sheet material provided can be stored in a storage apparatus, not shown in the drawings, when required.

Subsequently, it is determined whether the value corresponding to the applied impact is within a predetermined range of values stored in the impact application unit 101 (Step 303, FIG. 3). If the value of the applied impact does not fall into a predetermined range of values, the impact calibration unit 104 is notified, and calibration of the impact is carried out (Step S304, FIG. 3). For example, when a first signal corresponding to an impact applied without a sheet material provided and an initial setting signal corresponding to a predetermined range of impact are compare. If the difference of the signals is not included in a predetermined range, the impact is calibrated so that a predetermined signal is substantially the same as the first signal. The signals do not have to be exactly the same, and their difference may be, for example, within 20% of the output value of the initial setting signal. Various exemplary embodiments can reduce the difference to within 10% of the output value of the initial setting signal or even 5% of the output value of the initial setting signal, facilitating the improvement in the accuracy of identifying the type of the sheet material. To calibrate the impact, the velocity of the impact application member 201 is changed. The velocity of the impact application member 201 can be changed by, for example, changing the positions of the fixed shaft 204 and the cam 203, as shown in FIGS. 2A and 2B, with a unit not shown in the drawing. For example, if the strength of the impact is smaller than a predetermined value, the compression level of the spring 206 can be increased by moving the cam 203 and the fixed shaft 204 in the up direction indicated by the up portion of arrow AR2 in FIGS. 2A and 2B. By increasing the compression level of the spring 206, the impact application member 201 will move faster when released from the cam 203. The unit configured to move the cam 203 and the fixed shaft 204 can be an actuator, such as an electromagnetic motor, but is not limited. The velocity of the impact application member 201 can also be changed by changing the spring 206 and/or the cam 203. A data table, prepared in advance, indicating the height of the cam 203 corresponding to the strength of the impact to be applied can be used. After the position of the cam 203 is adjusted, the operation of the sheet identification apparatus 100 is repeated from the beginning.

If the value corresponding to the applied impact is within the range of values stored in the impact application unit 101, the sheet material 208 is conveyed along the sheet conveying guides 209A-B in the direction indicated by the arrow AR3. When the sheet material 208 reaches the area between the impact application member 201 and the piezoelectric element 202, a motor (not shown in the drawing) is controlled by the impact detection unit 103 of the control unit 102. As a result, the fixed shaft 204 is rotated in the direction indicated by the arrow AR1 so that the impact application member 201 applies an impact to the recording sheet 208, in a manner similar to the operation described above (Step 305, FIG. 3).

At this time, the piezoelectric element 202 generates a voltage signal corresponding to the impact transmitted through the sheet material 208. This voltage signal is sent to the sheet identification unit 105 of the control unit 102, shown in FIG. 1 (Step 306, FIG. 3).

Then, the sheet identification unit 105 of the control unit 102 identifies the sheet material 208 by referring to, for example, a data table of different sheet materials, provided in advance, corresponding to the impact detected by the impact detection unit 103 (Step 307, FIG. 3). Information for identifying a sheet material 208 is stored in advance in the sheet identification unit 105, as shown in FIG. 1. Any type of information can be provided in advance in accordance with the intended use of the sheet identification apparatus 100. The information may include, for example, data required for calibrating the strength of the impact, data on the relationship between the type, model, rigidity, thickness, roughness, type, or moisture content of the sheet material and the output from the piezoelectric element 202, a threshold value of an output signal used for identifying the sheet material, or the dependency of such information on temperature and humidity. When using copy machines and various printers, in addition to the information for identifying a sheet material, control conditions for controlling image formation conditions and the conveying conditions can be stored. Such information can be stored (e.g., in a ROM or a database).

To identify a plurality of sheet materials, Steps 305 to 307 are repeated.

Once the sheet material 208 is identified, the obtained information is sent to a control unit of the image forming apparatus and is used for determining image forming settings for the image forming apparatus.

Then, the process may be completed, as shown in FIG. 3, or, otherwise, may enter a stand-by mode to wait for the impact application member 201 to apply an impact again. This is because the identification process may be carried out every time a sheet material is passed through the sheet identification apparatus 100 or when a single sheet from a group of sheets passes through the sheet identification apparatus 100. For example, if a paper-feeding tray storing a stack of the same sheet material 208 is provided in the image forming apparatus, the same identification information, obtained from the first sheet from the group, can be used for each sheet material 208 until the paper-feeding tray is closed. In such a case, the identification process does not have to be carried out every time a sheet material is passed through the image forming apparatus.

As described above, the sheet identification apparatus 100 according to the first exemplary embodiment is capable of accurately identifying a sheet material even when the spring 206 is degraded and/or when condensation and/or disturbance are present. This is possible because the sheet identification apparatus 100 calibrates the sheetless impact from the impact application member 201.

The impact application member 201 of the sheet identification apparatus 100 according to the first exemplary embodiment is capable of applying an impact to the piezoelectric element 202 or a sheet material 208 by being accelerated by the spring 206 disposed in the guide 205. As a result, the identification process can be carried out at high speed. Accordingly, a sheet material 208 can be accurately identified even when the sheet material 208 is midway through the conveying path.

At least one further exemplary embodiment can include an impact reception unit configured to receive an impact applied by an impact application unit through a sheet material can have a depression, and the sheet material can be disposed so that sheet material is bent along the depression. In such a case, a signal corresponding to the flexural rigidity (bending) of the sheet material can be output from a signal output unit. The sheet material can be curved along the depression so that the tip (external force reception unit) of the impact application unit enters the depression.

The sheet material can be paper used for copy machines and/or printers or plastic sheets used for overhead projectors or other image holding sheets as known by one of ordinary skill in the relevant arts and equivalents.

The paper conveying guide 209B and the piezoelectric element 202, as shown in FIGS. 2A and 2B, are disposed flush to each other but are not limited to such positions. For example, the sheet conveying guide 209B and the piezoelectric element 202 may be disposed at different heights so that the sheet material 208 is bent. To bend the sheet material 208, a member that functions as an obstacle to the conveying of the sheet material 208 can be disposed downstream in the direction indicated by the arrow AR3 in FIG. 3, for example, on the left of the piezoelectric element 202, in FIGS. 2A and 2B. Looping of the sheet material 208 may occur so that the sheet material 208 is not in contact with the piezoelectric element 202. Furthermore, the piezoelectric element 202 and the sheet conveying guide 209B can be disposed at different heights so that the sheet material 208 is depressed.

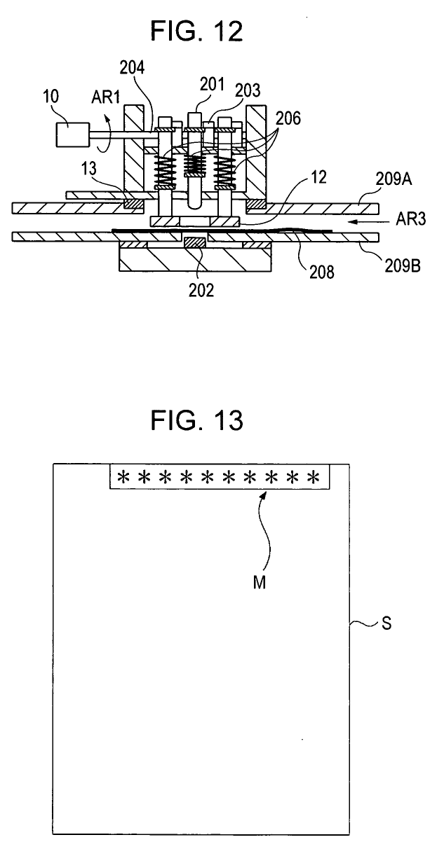

To stabilize the bending of the sheet material 208, for example, as shown in FIG. 12, a member configured to reduce flopping of the sheet material 208 can be provided. In FIGS. 2A and 2B, the impact application member 201 and the piezoelectric element 202 are disposed opposite to each other. However, their positions are not limited, and the impact application member 201 and the piezoelectric element 202 can be disposed approximately flush to each other.

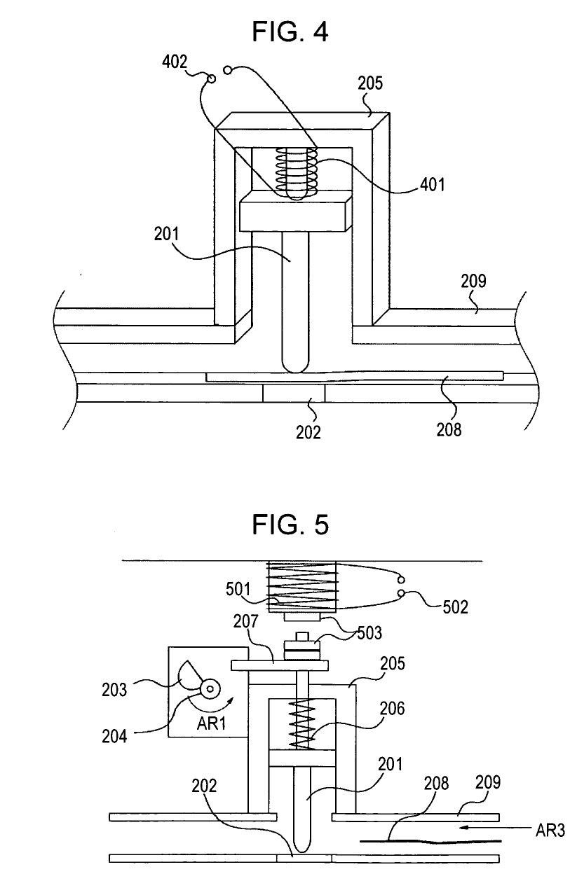

The method of generating and calibrating an impact is not limited to the above-described methods. For example, a solenoid 401 and a solenoid terminal block 402, as shown in FIG. 4, may be used instead. By changing the amount of electricity supplied from the solenoid terminal block 402, the impact can be adjusted or calibrated to equal a predetermined strength. Moreover, as shown in FIG. 5, a solenoid 501, a terminal block 502, and magnetic weights 503 can be used to change the weight of the impact application member 201. In a case in which an impact is applied by letting the impact application member fall freely, the distance the impact application member freely falls can be changed.

As described above, the piezoelectric element 202 can be used to detect an impact. However, the detection method is not limited, and any method of pressure detection can be employed. For example, a pressure sensor using the piezoelectric effect of a semiconductor, a displacement sensor using light, a pressure sensor using pressure-sensitive rubber, or a voice coil can be used along with other pressure detection methods as known by one of ordinary skill in the relevant arts and equivalents.

Calibration of the impact to be applied is not only carried out when there is a change in the environment, such as temperature and humidity, or when aging of components occurs, but also when the characteristics of the sheet material to be measured changes. For example, when measuring various types of recording paper, the strength of the impact can be changed to identify different types of thin paper, to identify different types of thick paper, or to categorize the paper into thin paper and thick paper. In such cases, information on the strength of the impact to be applied that is suitable for the sheet material to be measured can be stored in advance in the impact calibration unit 104 or the sheet identification unit 105. In the above examples of exemplary embodiments, the calibration of the impact is based on a change, over time, in the signal corresponding to an impact applied when a sheet material is not provided.

However, exemplary embodiments are not limited and can carry out calibration on the basis of other methods, for example a method described below.

An initial output signal is obtained by applying an impact with a reference sheet material (e.g., a standardized sheet material that is a sheet material satisfying predetermined standards on type, model number, rigidity, thickness, density, roughness, and moisture content) provided. Then, a current output signal by applying an impact with the reference sheet material being provided is obtained after a predetermined amount of time elapses or periodically. The values of these output signals are compared. When the difference between the value of the initial output signal and the values of the other output signals is greater than a predetermined value, the impact is calibrated in the same manner as described above. In such a case, the reference sheet material is not limited. However, one can use a sheet material that does not easily age and is resistant to environmental changes when the sheet material is to be used for a long period of time. For example, resin sheets or metal sheets can be suitable for reference sheet materials.

### Second Exemplary Embodiment

A sheet identification apparatus according to a second exemplary embodiment will be described with reference to FIG. 4. FIG. 4 is a perspective view illustrating the structure of an impact application unit according to the second exemplary embodiment.

The sheet identification apparatus according to the second exemplary embodiment is similar to that according to the first exemplary embodiment except that the pulling mechanism realized by an impact application member 201 is modified. Reference numerals in FIG. 4 that are the same as those in FIGS. 2A and 2B represent the components that have the same structure as those in FIGS. 2A and 2B and descriptions thereof are omitted.

As shown in FIG. 4, a solenoid 401 is disposed above the impact application member 201 and is held by the guide 205 so that the movement direction of the impact application member 201 is set. A solenoid terminal block 402 is a terminal configured to supply an electric current setting the attractive force of the solenoid 401.

Next, the operation of the sheet identification apparatus 100 according to the second exemplary embodiment will be described. Since the sheet identification apparatus 100 according to the second exemplary embodiment operates according to a process that is the same as that illustrated in FIG. 3, the operation of the sheet identification apparatus 100 according to the second exemplary embodiment will be described with reference to FIGS. 1, 3, and 4.

For example, if a sheet material 208 is not interposed between the impact application member 201 and the piezoelectric element 202 at the moment the power of the image forming apparatus is turned on, the solenoid terminal block 402 supplied with an electric current generates an attractive force that works on the solenoid 401 to pull up the impact application member 201. After a predetermined amount of time, the current supplied to the solenoid terminal block 402 is shut off, also shutting off the attractive force working on the solenoid 401. As a result, the impact application member 201 is released to directly apply an impact to the piezoelectric element 202 (Step 301, FIG. 3).

At this time, the piezoelectric element 202 generates a voltage signal corresponding to the impact applied directly to the piezoelectric element 202. This voltage signal is transmitted to the impact detection unit 103 of the control unit 102, shown in FIG. 1. In this way, the impact detection unit 103 detects the impact applied without a sheet material being disposed (Step 302, FIG. 3).

Subsequently, it is determined whether the value corresponding to the applied impact is within a predetermined range of values stored in the impact application unit 101. If the value of the applied impact does not fall into a predetermined range of values, the impact calibration unit 104 is notified. If the value of the applied impact is smaller than the range of values stored in the impact application unit 101, the attractive force working on the solenoid 401 can be increased by increasing the electric current supplied to the solenoid terminal block 402. If the value corresponding to the applied impact is larger than the range of values stored in the impact application unit 101, the attractive force working on the solenoid 401 can be decreased by decreasing the electric current supplied to the solenoid terminal block 402. After adjusting the current supplied to the solenoid terminal block 402, the operation of the sheet identification apparatus 100 is repeated from the beginning (Step S304, FIG. 3).

If the value corresponding to the applied impact is within the range of values stored in the impact application unit 101, the sheet material 208 is conveyed along the sheet conveying guide 209 in the direction indicated by the arrow AR3. When the sheet material 208 reaches the area between the impact application member 201 and the piezoelectric element 202, the impact detection unit 103 of the control unit 102 sends out a command to supply a predetermined electric current to the solenoid terminal block 402 again. As a result, the impact application member 201 is pulled up. Then, after a predetermined amount of time, the electric current is shut off, causing the impact application member 201 to be released. In this way, the impact application member 201 applies an impact to the sheet material 208 (Step 305, FIG. 3).

At this time, the piezoelectric element 202 generates a voltage signal corresponding to the impact transmitted through the sheet material 208. This voltage signal is transmitted to the sheet identification unit 105 of the control unit 102, as shown in FIG. 1 (Step 306, FIG. 3).

Then, the sheet identification unit 105 of the control unit 102 identifies the sheet material 208 by referring to, for example, a data table of different sheet materials, provided in advance, corresponding to the impact detected by the impact detection unit 103 (Step 307, FIG. 3).

The data table can include the maximum voltage values and voltage attenuation rates for different sheet materials. The data table is stored in a ROM or a database, not shown in the drawings.

Once the sheet material 208 is identified, the obtained information is sent to a control unit of the image forming apparatus and is used for determining image forming settings for the image forming apparatus.

Then, the process can be completed, as shown in FIG. 3, or, otherwise, may enter a stand-by mode to wait for the impact application member 201 to apply impact again. This is because the identification process can be carried out every time a sheet material is passed through the sheet identification apparatus 100 or when a single sheet from a group of sheets passes through the sheet identification apparatus 100. For example, if paper-feeding tray storing a stack of the same sheet material 208 is provided in the image forming apparatus, the same identification information, obtained from the first sheet from the group, can be used for each sheet material 208 until the paper-feeding tray is closed. In this way, the identification operation carried out each time the sheet material 208 is passed through can be omitted.

As described above, according to the sheet identification apparatus 100 according to the second exemplary embodiment, the interval of the impact strokes applied by the impact application member 201 can be shortened and the size of the sheet identification apparatus 100 can be reduced.

According to the second exemplary embodiment, the solenoid 401 can used to adjust the velocity of the impact application member 201. However, any other component can be used to adjust the velocity so long as the velocity of the impact application member 201 can be easily changed.

According to the above example of the second embodiment, an impact was calibrated on the basis of the change of a signal output when impact is applied without a sheet material provided over time.

However the second exemplary embodiment, is not limited to the above-described method of calibration. In other words, an impact can be calibrated using a reference sheet, as described above in one of the examples of the first exemplary embodiment.

### Third Exemplary Embodiment

Next, a sheet identification apparatus according to a third exemplary embodiment will be described with reference to FIG. 5. FIG. 5 is a cross-sectional view illustrating the structure of an impact application unit according to the third exemplary embodiment. Reference numerals in FIG. 5 that are the same as those in FIGS. 2A and 2B represent the components that have the same structure as those in FIGS. 2A and 2B and descriptions thereof are omitted. However, in this exemplary embodiment, the fixed shaft 204 only moves in the direction indicated by the arrow AR1.

As shown in FIG. 5, the solenoid 501 is disposed above the impact increasing member 207. The terminal block 502 is a terminal configured to supply an electric current that determines the suction force of the solenoid 401. An ‘n’ (n>1) number of weights 503 are provided. The weights 503 are magnetized by the solenoid 501 and are either attracted to the solenoid 501 or disposed above the impact increasing member 207, depending on the strength of the attractive force. The weights 503 can include a magnetic material.

Next, the operation of the sheet identification apparatus 100 according to the third exemplary embodiment will be described. Since the sheet identification apparatus 100 according to the second exemplary embodiment operates according to a process that is the same as that illustrated in FIG. 3, Step 304 in FIG. 3 will be described with reference to FIG. 5. Descriptions of other steps in the process are omitted.

After detecting the impact applied without a sheet material 208 provided, it is determined whether the value corresponding to the applied impact is within a predetermined range of values stored in the impact application unit 101. If the value corresponding to the applied impact does not fall into a predetermined range of values, the impact calibration unit 104 is notified. If the value corresponding to the applied impact is smaller than the range of values stored in the impact application unit 101, the electric current supplied to the terminal block 502 is reduced so as to increase the applied impact. In this way, the magnetism of the solenoid 501 is weakened, weakening the force attracting the weights 503. As a result, some of the weights 503 attracted to the solenoid 501 move to a position above the impact increasing member 207. If the value corresponding to the applied impact is larger than the range of values stored in the impact application unit 101, the electric current supplied to terminal block 502 is increased so as to decrease the applied impact. In this way, the magnetism of the solenoid 501 is strengthened, strengthening the force attracting the weights 503. As a result, some of the weights 503 are attracted to the solenoid 501.

The movement of the weights 503 changes the weight of the impact application member 201, and as a result, the strength of the applied impact is adjusted. A data table, prepared in advance, indicating the magnitude of the electric current corresponding to the impact to be applied can be used. After adjusting the current supplied to the terminal block 502, the operation of the sheet identification apparatus 100 is repeated from the beginning (Step 304, FIG. 3).

According to the third exemplary embodiment, the solenoid 501 can be used to adjust the weight of the impact application member 201. However, any components may be used adjust the weight of the impact application member 201 so long as the weight of the impact application member 201 can be easily changed.

As described above, the sheet identification apparatus 100 according to the first, second, or third exemplary embodiments can be installed in an image forming apparatus (e.g., a copy machine, a printer, a facsimile machine, other image forming apparatus as known by one of ordinary skill in the relevant arts and equivalents). However, the sheet identification apparatus 100 is not limited to image forming apparatus and can be installed in any type of apparatus (e.g., a ticket vending machine or an automatic vending machine, or any other apparatus that required the capability to identify a type of a sheet material).

According to the first and third exemplary embodiments, the spring 206 is used as a member to accelerate the impact application member 201. However, any other elastic member, such as a rubber member, may be used.

According to the first, second, and third exemplary embodiments, the piezoelectric element 202 generates a voltage signal corresponding to the impact applied by the impact application member 201. However, any other component that is capable of generating numeric data corresponding to the impact applied by the impact application member 201 can be used.

The voltage signal generated in accordance with the impact applied by the impact application member 201 by the piezoelectric element 202 according to the first, second, and third exemplary embodiments can be processed with, for example, a filter so as to remove noise or an amplifier so as to amplify the signal.

According to the above-described example of the third exemplary embodiment, an impact was calibrated on the basis of the change of a signal output when impact is applied without a sheet material provided over time.

The third exemplary embodiment, however, is not limited to the above-described example. In other words, an impact can be calibrated by with a reference sheet provided, as described in the one of the examples of the first exemplary embodiment.

### Fourth Exemplary Embodiment

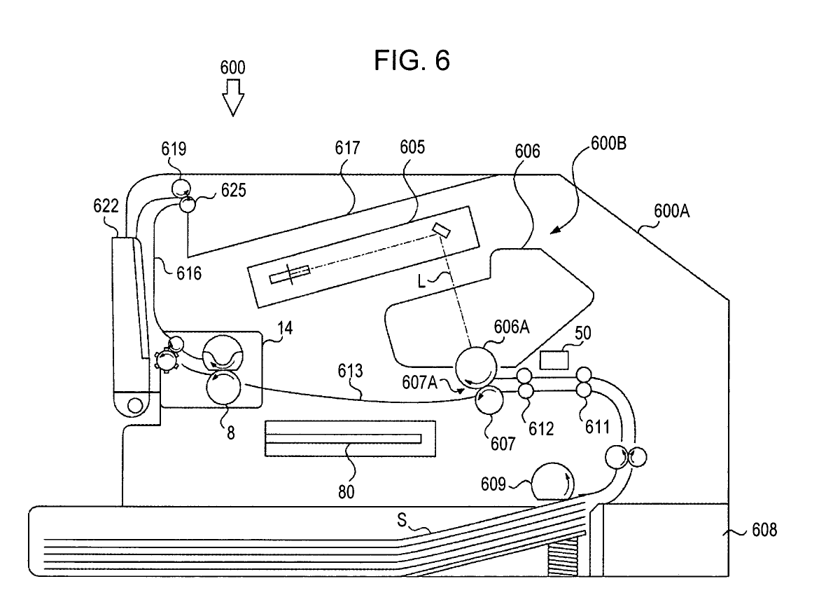

FIG. 6 is a schematic view of a laser beam printer that is an example of an image forming apparatus including a sheet identification apparatus according to at least one exemplary embodiment as a signal output apparatus. FIG. 6 illustrates a laser printer 600, a printer body 600A, and an image forming unit 600B.

According to the laser printer 600, when information is sent from an external information apparatus, such as a personal computer or a word processor (not shown in the drawing), an image signal corresponding to this information is generated by a video controller board (not shown in the drawing). Then, a laser scanner 605 scans the surface of a photosensitive drum 606A rotating (e.g., in a clockwise direction) with respect to a laser beam L corresponding to the image signal generated at the video controller board. In this way, an electrostatic latent image is formed on the photosensitive drum 606A.

After an electrostatic latent image is formed on the photosensitive drum 606A, the electrostatic latent image is developed into toner images in sequence by toner supplied from developing units included in a process unit 606, not shown in the drawing. Subsequently, the toner images are conveyed to a transfer section 607A form by the photosensitive drum 606A and a transfer roller 607.

Simultaneously to the toner image formation, a sheet S on the top of a stack of sheet materials loaded in a paper-feeding cassette 608 is sent out to a feeding path 610A one by one by a semi-circular feeding roller 609 that rotates 360 degrees in a counterclockwise direction. Then, conveying rollers 611 sends the sheet S to registration rollers 612 not rotating.

When the preceding edge of the sheet S reaches the nip between the registration rollers 612, misalignment of the sheet S is calibrated until predetermined looping occurs to the sheet S.

After the sheet S is aligned, the registration rollers 612 start to rotate and sends the sheet S to the transfer unit 607A at a timing in which the toner images on the photosensitive drum 606A are aligned with the sheet S. At the transfer unit 607A, the toner images on the photosensitive drum 606A are transferred onto the surface of the sheet S by the transfer roller 607.

Subsequently, the sheet S having the toner images transferred onto its surface is conveyed to a fixing unit 14 through a conveying guide 613. At the fixing unit 14, the sheet S is heated and pressurized so that the transferred toner images are fixed on the surface of the sheet S.

If the sheet S is to be stored with its image surface facing downwards after the fixing process on the sheet S is completed, the sheet S is sent through a conveying path formed by a conveying surface 616 and a face-up tray 622 opposing the conveying surface 616. Then, the sheet S is ejected onto a face-down tray 617 provided in the upper portion of the printer body 600A with a face-down roller 619 having a driving source not shown in the drawing and a driven roller 625 that is pressed against and driven by the face-down roller 619.

FIG. 6 illustrates a sheet identification apparatus 50 provided downstream of the image forming unit 600B, i.e., between the conveying rollers 611 and the registration rollers 612 according to this embodiment. The sheet identification apparatus 50 lets an impact application member collide with the sheet S. Then, a pressure sensor included in the sheet identification apparatus 50 detects the impact energy applied after some of the original impact energy is absorbed by the elasticity of the sheet S. An electric signal corresponding to the strength of the impact applied to the pressure sensor is output. The type of the sheet material is determined on the basis of the electric signal. FIG. 6 also illustrates a control unit 80 provided to control the image formation of the laser printer 600. The control unit 80 controls the image forming unit 600B on the basis of the electric signal sent from the sheet identification apparatus 50 so that an image is formed on the sheet S in accordance with conditions, such as the conveying speed and the fixing temperature, suitable for the sheet S.

The signal output apparatus according to this exemplary embodiment includes an impactor (impact application unit), an impact reception unit, and a pressure sensor. In at least one exemplary embodiment, the pressure sensor can also have the function as an impact reception unit. The pressure sensor can be disposed above or below the impact reception unit. The apparatus is configured to output a signal corresponding to an impact directly applied to the impact reception unit or applied to the impact reception unit through a sheet material interposed between the impact reception unit and the impact application unit. An impact reception unit configured to receive an impact applied by an impact application unit through a sheet material can have a depression, where the sheet material is curved along the depression. In such a case, a signal corresponding to the flexural rigidity (bending) of the sheet material can be output from a signal output unit. The sheet material can be curved along the depression so that the tip (external force reception unit) of the impact application unit enters the depression.

A sheet material can be paper used for copy machines and/or printers or plastic film used for an overhead projector or other image holding sheets as known by one of ordinary skill in the relevant arts and equivalents.

According to this exemplary embodiment, a signal (first signal) corresponding to the impact applied without a sheet material provided is detected and is compared with a predetermined signal (for example, an initial setting signal). Then, the value of the first signal is change to a value substantially equal to the value of a predetermined signal by changing the amplification of the signal output unit, including an amplifier capable of changing the amplification. The values of the signals do not necessarily have to be equal to each other and may be have, for example, a difference less than 20 percent.

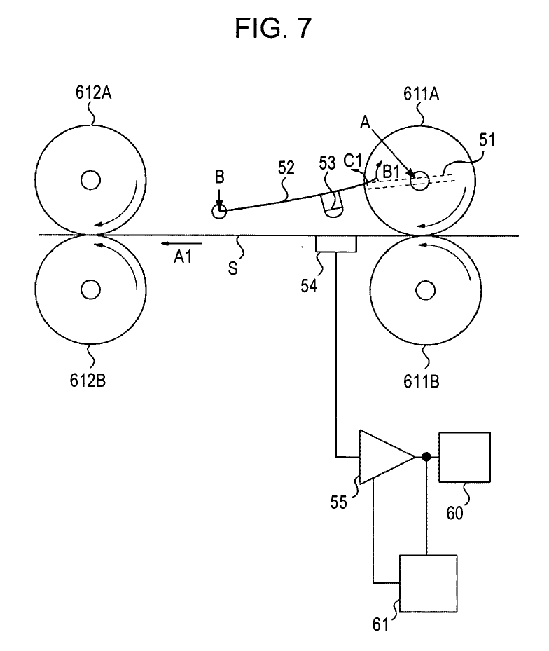

FIG. 7 illustrates an example of the sheet identification apparatus 50.

FIG. 7 illustrates a sheet S, a pair of conveying rollers 611A and 611B that rotate in the direction indicated by an arrow in the drawing so as to convey the sheet S and a pair of registration rollers 612A and 612B that rotate in the direction indicated by an arrow in the drawing so as to convey the sheet S in a direction A1.

A stress-generating member 51 is fixed to the shaft of conveying rollers 611A and rotated around a point A in the direction indicated by an arrow B1 in the drawing so as to apply an impact C1 to the sheet material. The stress-generating member 51 is slightly shorter than the diameter of the conveying rollers 611A and 611B. A stress-buildup member 52 according to this embodiment can be a flat spring with one of its ends fixed to a point B.

According to this exemplary embodiment, to apply an impact to the sheet material, the stress-generating member 51 is driven by a driving force of the shafts of the conveying rollers 611A and 611B. However, the driving force of the shafts of other rollers provided in the image forming apparatus can be used as well.

According to this exemplary embodiment, a roller shaft is used as the stress-generating member 51 to apply an impact to the sheet material. However, other mechanisms, such as plungers, capable of converting electric energy into mechanical energy can be used.

The stress-buildup member 52 according to this exemplary embodiment is a flat spring. However, a coil spring can be used instead.

An impactor 53 is provided as a single unit with the stress-buildup member 52. A pressure sensor 54 is configured to detect the impact energy generated as a result of the sheet material absorbing the stress applied by the impactor, which is provided as a single unit with the impactor 53.

The impactor 53 can be provided as unit with the stress-buildup member 52 and can be operated by letting it freely fall, instead of urging it with a spring.

The pressure sensor 54 converts mechanical energy into electric energy and can be a linear motor (voice coil), which is relatively resistant to mechanical damage, or a piezoelectric element, which can facilitate reducing the size of the apparatus.

An amplifier 55 is configured to amplify the electric signal obtained at the pressure sensor 54 to a predetermined voltage. A sheet identification unit 60 is configured to identify the type of the sheet S by storing, in advance, data corresponding to different types of sheet materials in a memory (not shown in the drawing) and by carrying out a comparative analysis of the stored data and the input voltage signal.

A storage unit 61 is configured to store initial setting of an output voltage sent from the amplifier 55. The storage unit 61 is also capable of changing the amplification of the amplifier 55 on the basis of the result of a comparative analysis of the initial setting and the current output voltage when the output voltage from the pressure sensor 54 changes due to environmental conditions.

For example, one way to change the amplification of the amplifier 55 is to change the ratio of the feedback resistance of the amplifier 55. Another way to change the amplification of the amplifier 55 is to change the amplification of an amplifier circuit including the amplifier 55 by using a variable resistor for the terminating resistor of the pressure sensor 54. However, exemplary embodiments are not limited to these methods and other methods of amplification adjustment as known by one of ordinary skill in the relevant arts and equivalents are included.

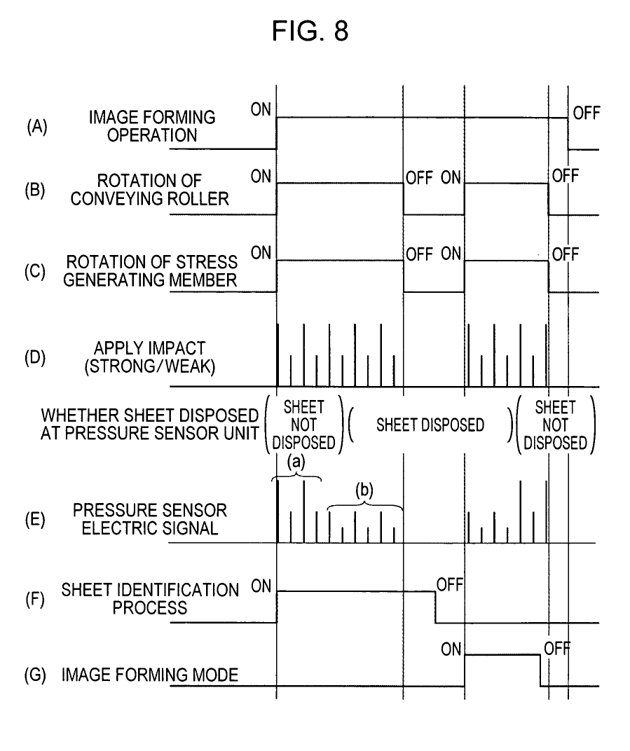

Next, the sheet identification operation carried out by the sheet identification apparatus 50 having the above-described structure will be described below with reference to a timing chart in FIG. 8.

When the laser printer 600 starts an image formation in response to a request by the user (“ON” in FIG. 8), a sheet S fed from the paper-feeding cassette 608 (refer to FIG. 6) is conveyed toward the registration rollers 612 by the conveying roller 611, as shown in the drawing.

Then, the stress-generating member 51 is fixed to the shafts of the conveying roller 611A and rotates around a point A shown in the drawing in the direction indicated by an arrow. The stress-buildup member 52 repeats the following operation. More specifically, the stress-buildup member 52 is slightly shorter than the diameter of the conveying rollers 611 and repeatedly pushes up and releases the stress-buildup member 52.

At this time, the stress-generating member 51 does not affect the conveying process of the sheet S since the stress-generating member 51 is slightly shorter than the diameter of the conveying roller 611A.

The point of the stress-buildup member 52 that is pushed by the stress-generating member 51 can be changed by changing the length of the stress-generating member 51. In other words, the stress built up in the stress-buildup member 52 and, as a result, the strength of the impact applied by the impactor 53 can be changed.

By increasing the number of the stress-generating members 51, the stress-buildup member 52 can be pushed up and released in a short period of time. In other words, many impact strokes can be applied to the sheet S in a short period time to obtain data on the elasticity of the sheet S.

By applying impact strokes repeatedly to the sheet S and by changing the strength of the applied impact, a plurality of data sets on the elasticity of the sheet S can be obtained. In this way, the type of the sheet material can be identified more accurately.

The stress-buildup member 52 pushed up and released by the stress-generating member 51 is fixed at one of its end at a point B. Therefore, while the stress-buildup member 52 is being pushed up, it gradually builds up stress. Then, when the stress-buildup member 52 is released, it repels at once. As a result, the impactor 53 provided as a single unit with the stress-buildup member 52 transmits impact energy to the pressure sensor 54 through the sheet S.

Electric signals obtained when the impactor 53 applies an impact to the pressure sensor 54 through the sheet S is stored in advance in a memory (not shown in the drawing) as data corresponding to the type of the sheet S. A comparative analysis of this data and the data obtained as described above is carried out. In this way, the sheet identification unit 60 identifies the type of the sheet S.

Accordingly, when changes in the external environment, such as changes in temperature and/or humidity, occur or when aging of the stress-buildup member 52 occurs, the output voltage obtained from the pressure sensor 54 can be changed, causing the accuracy of the sheet type identification to be reduced. By carrying out the process described below, however, the identification accuracy can be improved.

The sheet S is conveyed by the conveying rollers 611A-B. If the sheet S does not reach the line corresponding to the impactor 53 and the pressure sensor 54, the impactor 53 directly applies an impact to the pressure sensor 54. The electric signal obtained at the pressure sensor 54 at this time is defined as a reference electric signal used for obtaining data on the elasticity of the sheet S ((a), FIG. 8E).

By carrying out this operation, the impactor 53 can be calibrated for each sheet material S. As a result, the output signal (or reference electric signal) obtained when directly applying an impact to the pressure sensor 54 is improved even when the flat sprint of the stress-buildup member 52 undergoes a change due to a change in the environment.

Moreover, conditions of the initial output voltage are stored in the storage unit 61. When a change due to a change in the environmental conditions occurs in the output voltage used as a reference, a comparative analysis of the data stored in the storage unit 61 and the data obtained as described above is carried out. By changing the amplification of the amplifier 55, the output voltage corresponding to the “sheet not disposed” area (a), shown in FIG. 8E, is output under conditions substantially the same as the initial settings.

In some cases, even if the amplification of the amplifier 55 is changed, the output voltage corresponding to the “sheet not disposed” area (a) of FIG. 8E may not be output in accordance with conditions substantially the same as the initial setting. In such a case, an indication that the sheet identification unit is malfunctioning due to a damage or age may be output.

When the sheet S is conveyed by the conveying rollers 611A-B and reaches the line corresponding to the impactor 53 and the pressure sensor 54, the impactor 53 applies an impact to the pressure sensor 54 through the sheet S.

The value of the electric signal obtained at the pressure sensor 54 at this time can be smaller than the value of the electric signal corresponding to the reference voltage obtained at the pressure sensor 54 by directly applying an impact to the pressure sensor 54 by the impactor 53 because some of the impact energy is absorbed by the elasticity of the sheet S ((b), FIG. 8E).

At this time, since the amplification of the amplifier 55 has been changed in the previous step, the output voltage corresponding to the “sheet disposed” area (b) in FIG. 8E is output as described below. In other words, if the elasticity of the sheet S is the same, the output voltage is output in accordance with conditions substantially the same as the initial setting.

Consequently, the accuracy of the sheet type identification is improved even when the stress-generating member 51, the stress-buildup member 52, the impactor 53, and the pressure sensor 54 undergo changes due to environmental conditions, causing the overall sensitivity of the apparatus to be reduced. This is because, the output voltage sent from the sheet identification unit 60 becomes substantially the same as the initial voltage and the signal-to-noise (S/N) ratio is improved.

The impact energy absorbed by the elasticity of the sheet S differs depending on the characteristics of the sheet S, such as thickness or hardness.

Then, the reference electric signal obtained by directly applying an impact to the pressure sensor 54 with the impactor 53 is compared with the electric signal obtained by applying an impact to the pressure sensor 54 through the sheet S with the impactor 53. The characteristics of the sheet S can be identified on the basis of the result of the comparison.

Then, the reference electric signal obtained in advance by directly applying an impact to the pressure sensor 54 with the impactor 53 is compared with the electric signal obtained by applying an impact to the pressure sensor 54 through the sheet S with the impactor 53. The result of the comparison is stored in a memory (not shown in the drawings) as data corresponding to the type of sheet S. The sheet identification unit 60 identifies the type of the sheet S by carrying out a comparative analysis using the data stored in the memory and the data obtained as described above.

Then, in a sheet identification process shown in FIG. 8F, a sheet identification signal is sent from the sheet identification unit 60 to the control unit 80 after the type of the sheet S is identified. The control unit 80 optimizes the image forming mode during a period shown in FIG. 8G corresponding to the image forming mode by controlling the conveying speed, the fixing temperature, and/or the discharge amount of ink in accordance with the sheet identification signal.

In this way, an impactor 53 (impact application member) configured to apply an impact to a sheet material is provided in the image forming apparatus. The impactor 53 applies an impact to the sheet material, and a pressure sensor detects the impact energy after the impact is absorbed by the sheet material so as to obtain an electric signal. If required, another electric signal is obtained by directly applying an impact to the pressure sensor with the impactor without a sheet material provided. The type of sheet material is identified on the basis of these electric signals. The following operation is carried out when the electric signal obtained by directly applying an impact to the pressure sensor with the impactor without a sheet material provided changes due to a change in the environment. More specifically, the type of the sheet material can be identified by obtaining an output voltage substantially the same to the initial setting by changing the amplification of an amplifier provided to amplify the output voltage from the pressure sensor. As a result, the type of the sheet material S can be identified by a simple structure without marking the sheet material S.

The sheet identification apparatus according to examples of at least one exemplary embodiment discussed, are mounted horizontally. However, the sheet identification apparatus according to the exemplary embodiments are not intended to be limited by the examples provided and thus can also be mounted vertically as well.

The sheet identification apparatus according to an example of at least one exemplary embodiment is disposed immediately after the conveying rollers 611. However, the sheet identification apparatus according to at the exemplary embodiments can also be disposed at any position between the paper-feeding cassette 608 and a point immediately before the transfer unit 607A.

To determine whether a signal sent from the signal output unit corresponds to a case in which the sheet material is provided or a case in which the sheet material is not provided, the following structure may be provided. In other words, a sheet detection device (for example, a light detection device that is capable of receiving different amount of light depending on whether or not a sheet material is provided) can be provided. Warning information noticeable by the user can be output by the image forming apparatus when a desired output signal cannot be obtained even when the amplification of the amplifier is changed.

FIG. 6 illustrates the sheet identification apparatus 50 interposed between the registration rollers 612 and the conveying rollers 611. An output signal from the sheet identification apparatus 50 is sent to the control unit 80 configured to control the image formation of the laser printer 600 so as to control the conveying speed, fixing temperature, and transfer conditions in accordance with the recording paper.

Details of the operational principle of sheet identification apparatus is shown in FIG. 7. The pair of conveying rollers 611A and 611B and the pair of registration rollers 612A and 612B rotate in the direction indicated by the arrows to convey the sheet S in the direction indicated by an arrow A1. The stress-generating member 51 is fixed to the rotary shaft of the conveying roller 611A. In FIG. 7, the stress-generating member 51 is rod-shaped. However, the shape of the stress-generating member 51 is not limited so long as the stress-generating member 51 is shorter than the diameter of the conveying roller 611A. The stress-buildup member 52 is a flat spring fixed to the point B in the drawing. The drawing also shows the impactor 53. In addition, FIG. 7 shows the impact detection unit (pressure sensor) 54, the impact calibration unit (amplifier) 55, and the sheet identification unit 60. The storage unit 61 stores the initial values of the impact calibration unit 55. In the drawing, the impact calibration unit 55 is provided separately from the sheet identification unit 60. However, the units 55 and 60 can be provided as a unit.

FIG. 8 illustrates the concept of the sheet identification process. The conveying rollers 611A-B are rotated so that stress is applied to the stress-buildup member 52 by the stress-generating member 51 before the sheet S reaches the conveying rollers 611. The rotation of the stress-generating member 51 causes the stress-buildup member 52 to be released so that the impactor 53 applies an impact to the impact detection unit 54. At this time, the output from the impact detection unit 54 is compared with the data stored in the storage unit 61 without carrying out calibration. If there are no problems detected when the output is compared to the initial data, a signal is sent to the control unit 80, shown in FIG. 6, to start the conveying of the sheet material. Whether or not a sheet material is provided, the number of strokes and strength of the impact to be applied is not limited. In other words, the strength of the impact to be applied is not limited so long as there is no mechanical change in composition, such as damage to the sheet material or an interruption in the image formation. The number of strokes of impact applied, (e.g., the time interval between strokes), is not limited as well.

If there are no problems detected with the output when a sheet material is not provided, an impact is applied by the impactor 53 to the sheet material conveyed by the conveying rollers 611 in the same manner as when a sheet material is not provided. The signal output at the impact detection unit 54 is sent to the sheet identification unit 60 in the same manner as the initial conditions so as to transmit the information on the sheet materials S to the control unit 80. The control unit 80 starts the image formation.

If the output signal from the impact detection unit 54 with a sheet material not provided does not agree with the initial conditions stored in the storage unit 61, calibration of the output signal is carried out by the impact calibration unit 55 so as to obtain a signal having a predetermined value. Then, the information on the sheet material is sent to the control unit 80 by the sheet identification unit 60 to enable image formation suitable for the sheet material.

The impact calibration unit 55 carries out calibration of the signal sent from the impact detection unit 54. If the signal sent from the impact detection unit 54 is a voltage signal, calibration can be carried out by amplifying or attenuating the voltage. For example, to amplify a signal, the feedback resistance ratio of the amplifier can be changed or the amplification of the amplifier circuit can be changed by using a variable resistor at the terminal resistor of the impact detection unit 54. Moreover, calibration can be carried out by differentiating or integrating. Such methods can be combined with the amplification or attenuation of the signal to carry out calibration. In general, calibration is required when environmental conditions, such as temperature and humidity, change or when various components, such as components included in the printer body, age. Moreover, calibration can be required when image formation is carried out under special conditions.

The sheet identification unit 60 stores, in advance, information for identifying a sheet material. This information can be set freely in accordance with the intended use of the apparatus. Such information includes, for example, the rigidity, thickness, density, roughness, type, or moisture content of the sheet material and the output from the piezoelectric element 202, a threshold value of the output signal used for identifying the sheet material, or dependency of such information on temperature and humidity. When using copy machines and various printers, in addition to the above-mentioned information, control conditions for controlling the image formation conditions and the conveying conditions of the sheet materials can be stored. Such information can be stored in a ROM or a database, for example. Moreover, when the initial conditions cannot be reproduced even when calibration of the impact is carried out, a warning signal can be output to notify the user of the printer and to stop the image formation.

According to the above-described examples of the fourth exemplary embodiment, an impact was calibrated on the basis of the change of a signal output when impact is applied without a sheet material provided over time.

Exemplary embodiments, however, are not limited to the above-described example of the fourth exemplary embodiment. In other words, an impact can be calibrated by with a reference sheet provided, as described in the first exemplary embodiment.

### EXAMPLES

Examples of the exemplary embodiments will be described blow.

### First Example

FIG. 1 is a block diagram of the sheet identification apparatus 100 according to at least one exemplary embodiment. The sheet identification apparatus 100 includes the impact application unit 101, the control unit 102, the impact detection unit 103, the impact calibration unit 104, and the sheet identification unit 105.

Details of the structures of the impact application unit 101, the impact detection unit 103, and the impact calibration unit 104 are shown in FIG. 2. In FIGS. 2A and 2B, the impact application unit 101 includes the cam 203 that rotates in the direction indicated by the arrow AR1 and that is fixed to the fixed shaft 204, the spring 206, the impact increasing member 207, the impact application member 201, and the guide 205. The impact calibration unit 104 includes a driving unit, not shown in the drawing, configured to move the fixed shaft 204 and the cam 203 in the direction indicated by the arrow AR2. The sheet material 208 is conveyed by a driving unit, not shown in the drawing, in the direction indicated by the arrow AR3 through the sheet conveying guides 209A and 209B.

The steps of the sheet identification process according to this example will described with reference to FIG. 3. To identify a sheet material, first, the cam 203 and the fixed shaft 204 are rotated in the direction indicated by the arrow AR1 with out a sheet material provided. Then, the spring 206 is compressed and, then, released. In this way, an impact is applied to the piezoelectric element 202, which is also the impact detection unit, by the impact application member 201 (Step 301, FIG. 3). At this time, the output from the piezoelectric element 202 is compared with a predetermined output value (Step 303, FIG. 3) (refer to FIG. 2A). As a result of the comparison, if the output value from the piezoelectric element 202 is the same as the predetermined output value, the sheet material 208 is conveyed by a unit, not shown in the drawings, and an impact is applied to the sheet material 208 in the same manner as described above (Steps 305 and 306, FIG. 3) (refer to FIG. 2B). The sheet material 208 is identified by comparing the output from the impact with the piezoelectric element 202 obtained with a sheet material provided and information stored in the sheet identification apparatus (Step 307, FIG. 3). When a plurality of sheet materials is to be measured, the process is returned to Step 305 and the subsequent steps are repeated.

In step 303, if the output value obtained in Step 302 differs from the predetermined output value, the process proceeds to Step 304. If the strength of the impact is weaker than the strength corresponding to the predetermined value, the cam 203 and the fixed shaft 204 are moved in the up direction indicated by the up portion of the arrow AR2 in FIG. 2A. In this way, the spring 206 can be greatly compressed to generate a stronger impact force compared to before the cam 203 and the fixed shaft 204 are moved when the impact increasing member 207 is released due to the rotation of the cam 203. The Steps 301 to 304 are repeated as many times are required to carry out calibration of the impact force to obtain an impact corresponding to the predetermined value. In this way, the impact applied when a sheet material is not provided can be maintained at a constant value.

A recording paper for electrophotography was measured using the sheet identification apparatus according to an exemplary embodiment. The sheets of recording paper measured were Badger Bond 60 (BB60), Xerox 75 (Xx75), Neenah Classic 90 (NCL90), Hammer Mill 120 (HM120), and film for a Canon electrophotography overhead hoist transport (OHT) (CG3300). According to this example, the total weight of the impact increasing member 207 and the impact application member 201 was 3.9 g, and the velocity of the impact application member 201 applying an impact to the sheet material 208 is 0.48 m/s. The output from the piezoelectric element 202 was 12±0.2 V when an impact was applied under these conditions. This value was set as the setting value for a case in which a sheet material is not provided.

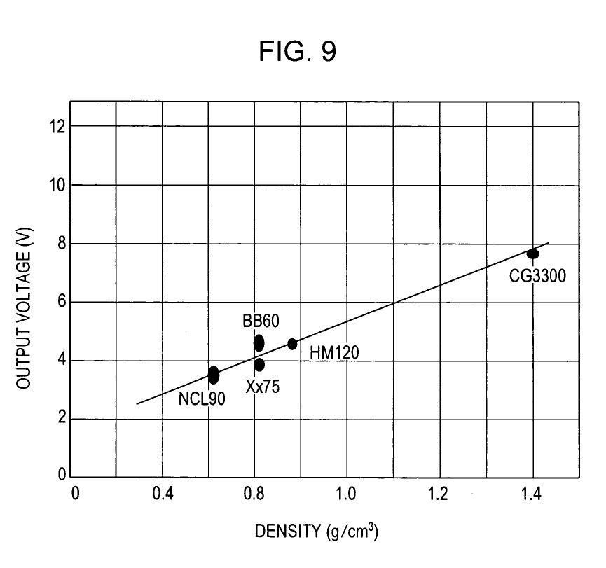

The recording paper was identified in accordance with the steps illustrated in FIG. 3. The measurements results corresponding to a normal impact application is shown in FIG. 9. In the graph shown in FIG. 9, the vertical axis represents the output voltage of the sheet identification apparatus according to an exemplary embodiment, and the horizontal axis represents the density of the recording paper calculated from the size and the thickness of the sheet. The size of the dots plotted on the graph represents the dispersion of the results of fifty measurements.

As the number of impact strokes applied increases, the output voltage from the piezoelectric element when a recording paper is not provided decreases due mainly to the aging of the spring 206. For example, after 1.2 million strokes, the output voltages when a recording paper is not provided were less than 11 V in some cases. If an impact is applied to a sheet of recording paper in such a case, the output from the piezoelectric element decreases. For example, the voltage values obtained for the recording paper BB60 and CG3300 were smaller than 7 V. The cam 203 and the fixed shaft 204 were moved by a motor, not shown in the drawings, so that the output voltage when a recording paper is not provided was 12±0.2 V. In this way, the compression rate of the spring 206 was increased. According to this example, the cam 203 and the fixed shaft 204 were moved by 1 mm in the direction indicated by the arrow AR2. Then, measurements of the sheets of recording paper were carried out. According to these measurements, the results shown in FIG. 9 were reproduced for all types of recording paper mentioned above.

### Second Example

The signal output apparatus according to an embodiment was mounted on a laser beam printer. The structure of the laser printer 600 is shown in FIG. 6. FIG. 6 illustrates the sheet identification apparatus 50. FIG. 7 shows details of the structure of the sheet identification apparatus 50. FIG. 8 shows the image forming process carried out by the sheet identification apparatus 100.

When the image formation process is started, the sheet S is fed one sheet at a time by the paper-feeding roller 609, as shown in FIG. 6. The sheet S passes through a paper-feeding path 610A and reaches the conveying rollers 611. As shown in FIG. 7, the stress-generating member 51 can be attached to the conveying roller 611A. The stress-generating member 51 rotates around the center point A in the direction indicated by the arrow B1 in the same direction as the conveying roller 611A. The rotation of the conveying rollers 611 causes the stress-generating member 51 to push up the stress-buildup member 52. Then, further rotation of the conveying rollers 611 causes the stress-buildup member 52 to be released. At this time, the released stress-buildup member 52 applies an impact to the impact detection unit 54 by the impactor 53 because one end of the stress-buildup member 52 is fixed at the point B, as shown in FIG. 7. This process is repeated while the conveying rollers 611 are rotating.

As shown in FIG. 7, the stress-generating member 51 is asymmetrical with respect to the rotational center A. Accordingly, two different magnitudes of stress are built up in the stress-buildup member 52. As a result, two strokes of impact (one hard stroke and one weak stroke) are applied by the stress-generating member 51 while the conveying rollers 611 rotate once (FIG. 8D). When the conveying rollers 611 rotate twice, the sheet S is conveyed to the impact detection unit 54. Then, the two strokes (one hard stroke and one weak stroke) of impact are repeatedly applied to the sheet S. When no sheet material is provided, the output from the impact detection unit 54 is compared with the data stored in the storage unit 61. Then, the output is calibrated by the impact calibration unit 55 (e.g., amplifier) so that its value equals the value stored in the storage unit 61 ((a), FIG. 8E). On the basis of the percentage of this calibration, the output corresponding to the impact applied to the sheet S is calibrated ((b), FIG. 8E). Information required by the sheet identification unit 60 in accordance with the calibrated value is sent to the control unit 80, shown in FIG. 6, to start the image forming process (FIG. 8G).

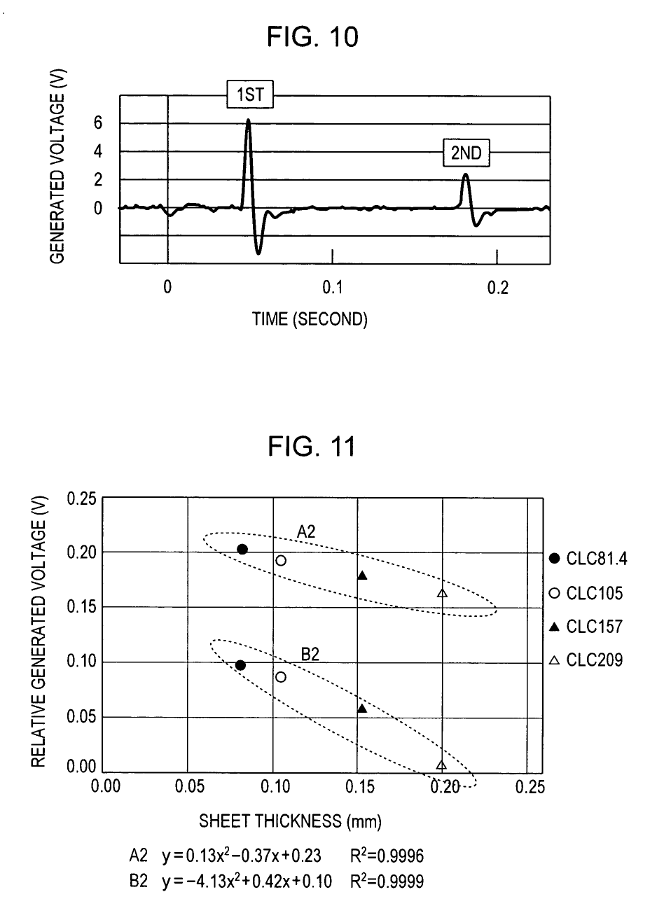

Details of an exemplary process that has been carried out are described below. A flat spring was used as the stress-buildup member 52, and the impactor 53 was an 8-gram stainless steel weight. FIG. 10 shows the output from the impact detection unit 54 when the velocities of the impactor 53 upon the impact detection unit 54 is 0.48 m/s and 0.23 m/s. The average value of fifty measurements made under these conditions was stored in the storage unit 61. In FIG. 7, the conveying surface of the sheet S and the impact detection unit 54 are disposed flush to each other. In the measurement according to this example, however, the impact receiving surface of the sensor used to detect the impact was depressed by 0.3 mm compared to the conveying surface of the sheet S. According to this example, a 5 mm×5 mm×100 μm piezoelectric element was used as a sensor.

Next, measurements for thick paper will be described. Measurement results of a sheet of CLC paper (a Canon product) that is used for electrophotography is shown in FIG. 11. The sheet was measured while being conveyed at a speed of 20 cm/s. In the graph shown in FIG. 11, the horizontal axis represents the thickness of the CLC paper having different basic weights, and the vertical axis represents the outputs from the piezoelectric element. The thickness of twenty sheets of paper was measured with a micrometer. The thickness of ten random points on each sheet were measured, the average value was calculated. The output from the piezoelectric element corresponds to the relative generated voltage for the voltage when a sheet is not provided. In FIG. 8, the rotation of the conveying rollers 611 appears to be stopped at the third turn. However, the rotation of the conveying rollers 611 is not limited. FIG. 11 was prepared by using the average value calculated after three signals generated by applying impact to the recording paper are received. The oval area A2 in FIG. 11 represent the measurement results corresponding to the first (i.e., strong) impact applied, and the oval area B2 represent the measurement results corresponding to the second (i.e., weak) impact applied. The voltage associated with area A2 could be approximated by a quadratic function, y=0.13x²-0.37x+0.23 (correlation coefficient R²=0.9996), where x represents the thickness of the recording paper and y represents the relative voltage. The voltage associated with area B2 could be regressed to the quadratic function, y=−4.13x²-0.42x+0.09 (correlation coefficient R²=0.9999). These results were stored in advance in the sheet identification unit 60 (FIG. 7) or the storage unit 61.

After information on cases in which recording paper is provided and not provided are stored in the storage unit 61 and the impact detection unit 54, the actual image forming process is carried out. Even if an unknown paper is used, the thickness of the paper can be calculated on the basis of the regression curve, shown in FIG. 11. Then, the optimal image forming conditions can be set for the thickness. For example, a laser beam printer according to an exemplary embodiment can use CLC81.4 paper and CLC209 paper, the fixing temperature for the CLC209 paper is set about 15 degrees higher than that of the CLC81.4 paper. When these two different types of paper are both used, in known laser beam printers, the fixing temperature is set in accordance with the higher temperature. However, for the laser beam printer according to an exemplary embodiment, an optimal fixing temperature can be selected on the basis of the thickness of the paper used by referring to the regression curved shown in FIG. 11, thus unnecessary electric consumption is reduced when using the CLC81.4 paper, and curling of the paper can be significantly reduced.

According to this example, impacts were applied in two different strengths. However, the strength of the applied impact is not limited. As described above, the thickness of an unknown paper can be obtained by referring to two regression curves, as shown in FIG. 11, and, then, the image forming conditions may be determined on the basis of the average value of the thickness. However, the identification process can also be based on only one regression curve as well. The strong and weak strokes of impact can be used to obtain different types of information, where the strong impact is used to measure the density and the weak impact is used to determine the thickness of the paper. The number of strokes, the strength of the impact. Likewise in exemplary embodiments the frequency of the strokes is not limited. Moreover, the position where an impact is applied to a sheet material is not limited to the vicinity of the registration rollers, as shown in FIG. 6.

As described above, an apparatus according to exemplary embodiments, can measure quickly and easily dynamic information on sheet material. Moreover, by providing calibration devices, the reliability of the apparatus is significantly improved.

According to a signal output apparatus according to an exemplary embodiment, the impact application unit provided as impact application device, is capable of carrying out calibration of an impact to be applied to a sheet material. In this way, stable strokes of impact can be applied to the sheet material.

Moreover, since the impact application unit stabilizes the impact received via the sheet material, improved identification of the sheet material can be carried out. Accordingly, an optimal fixing temperature and an optimal amount of ink can be set in accordance with the type of sheet material. In this way, images with improved quality can be provided while electric power consumption and ink consumption can be reduced.

According to at least one exemplary embodiment, the amplification of a signal from the signal output unit can be changed. In this way, the signal output from the signal output unit when a sheet material is not interposed between the impact application unit and the impact reception unit can be amplified so that the value of the signal equals a predetermined value.

As described above, the sheet identification apparatus according to at least one exemplary embodiment is suitable for identifying a sheet material used for image formation carried out by an image forming apparatus. In particular, the sheet identification apparatus is suitable for an image forming apparatus required to carry out high quality image formation.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-379831 filed Dec. 28, 2004 and No. 2004-379830 filed Dec. 28, 2004 and No. 2005-319644 filed Nov. 2, 2005, which are hereby incorporated by reference herein in their entirety.

What is claimed is:

1. A signal output apparatus comprising:
an impact application unit configured to generate and apply an impact to a sheet material;
an impact reception unit configured to receive the applied impact;
a signal output unit configured to output a signal in response to the impact received by the impact reception unit from the impact application unit, the signal output unit being disposed on at least one of the impact application unit side and the impact reception unit side; and
a calibration unit configured to calibrate at least one of the impact applied by the impact application unit and the signal output from the signal output unit.

2. The signal output apparatus according to claim 1, wherein the calibration unit carries out one of adjusting the impact and changing the output signal when the value of an output signal obtained by applying an impact without a sheet material being provided is not included in a predetermined range.

3. The signal output apparatus according to claim 1, wherein,
the calibration unit carries out calibration on the basis of a signal output from the signal output unit in response to the impact being received by the impact reception unit from the impact application unit while the sheet material is not interposed between the impact application unit and impact reception unit.

4. The signal output apparatus according to claim 3, wherein,
the impact application unit includes an impact generation unit and an impact application member, and
the impact application unit carries out calibration of the impact by changing the velocity of the impact application member.

5. The signal output apparatus according to claim 3, wherein,
the impact application unit includes an impact generation unit and an impact application member, and
the impact application unit carries out calibration of the impact by changing the weight of the impact application member.

6. The signal output apparatus according to claim 3, wherein,
the impact application unit includes an impact generation unit and an impact application member, and
the impact application unit carries out calibration of the impact by changing the distance between the impact application unit and the impact reception unit.

7. The signal output apparatus according to claim 1, wherein,
the calibration unit includes a signal processing unit having a signal processing function for processing the signal output from the signal output unit on the basis of at least one of an amplification, an attenuation, an integration, and a differentiation, the signal processing function being changeable.

8. The signal output apparatus according to claim 7, wherein the signal processing function of the signal processing unit is changed so that the signal output from the signal output unit in response to the impact received by the impact reception unit from the impact application unit has a predetermined value while the sheet material is not interposed between the impact application unit and impact reception unit.

9. The signal output apparatus according to claim 1, further comprising:
a warning signal output unit configured to output an warning signal when the signal output from the signal output unit does not have a predetermined value after calibration on at least one of the impact generated by the impact application unit and the signal output from the signal output unit is carried out.

10. An image forming apparatus comprising:
the signal output apparatus according to claim 1; and
a storage unit configured to store information on a sheet material,
wherein the image forming apparatus has a function for identifying a sheet material on the basis of an output signal from the signal output apparatus and information stored in the storage unit.

11. An image forming apparatus comprising:
the signal output apparatus according to claim 1;
a conveying unit configured to convey a sheet material; and
an image forming unit configured to form an image on the sheet material,
wherein the image forming apparatus is capable of controlling image forming conditions on the basis of a signal sent from the signal output apparatus.

12. A method for identifying a sheet material comprising the steps of:
obtaining a first output signal by applying a first impact by an impact application unit to an impact reception unit without a sheet material;
adjusting the first impact so that the value of a first output signal corresponding to the first impact is within a predetermined range;
applying a predetermined second impact by the impact application unit to the impact reception unit with a sheet material being provided;
outputting the second impact applied to the sheet material as a second output signal from the impact reception unit; and
identifying the sheet material on the basis of the second output signal and information provided in advance for identifying the sheet material.

13. A method for identifying a sheet material comprising the steps of:
obtaining a first output signal from a signal output unit by applying a first impact by an impact application unit to an impact reception unit without a sheet material;
changing the signal output unit so that the value of the first output signal will be included within a predetermined range;
applying a predetermined second impact by the impact application unit to the impact reception unit with a sheet material being provided;
outputting the second impact applied to the sheet material as a second output signal from the impact reception unit; and
identifying the sheet material on the basis of the second output signal and information provided in advance for identifying the sheet material.

14. The signal output apparatus according to claim 1, wherein the calibration unit carries out one of adjusting the impact and changing the output signal when the value of an output signal obtained by applying an impact to a reference sheet material is not included in a predetermined range.

15. A method for identifying a sheet material comprising the steps of:
obtaining a first output signal by applying a first impact by an impact application unit to an impact reception unit to a reference sheet material;
adjusting the first impact so that the value of a first output signal corresponding to the first impact is within a predetermined range;
applying a predetermined second impact by the impact application unit to the impact reception unit with a sheet material being provided;
outputting the second impact applied to the sheet material as a second output signal from the impact reception unit; and
identifying the sheet material on the basis of the second output signal and information provided in advance for identifying the sheet material.
